(19) United States
(12) Patent Application Publication
(10) Pub. No.: US 2014/0106635 A1
(43) Pub. Date: Apr. 17, 2014

(54) RADIOPAQUE CARBON-CARBON LINKED ELASTOMERIC MATERIALS, PREPARATION METHOD AND USES OF SAME

(71) Applicant: José Colombo Junior, Jundiai (BR)

(72) Inventor: José Colombo Junior, Jundiai (BR)

(73) Assignee: PLANIDEIA CONFECÇÃO DE VESTUÁRIO DE PROTEÇÃO LTDA. -EPP, Cotia (BR)

(21) Appl. No.: 14/116,652

(22) PCT Filed: Sep. 23, 2011
(86) PCT No.: PCT/BR2011/000377

§ 371 Date: Nov. 8, 2013

(51) Int. Cl. G21F 1/12; G21F 3/00; G21F 3/02; G21F 3/04

(52) U.S. Cl. CPC G21F 1/12; G21F 3/04; G21F 3/00; G21F 3/02
USPC 442/1; 428/221; 250/517.1; 250/515.1; 250/516.1; 252/478; 156/60

(57) ABSTRACT

An elastomeric matrix impregnated with at least 70% by weight of a high atomic number radiopaque substance, and cured with an organic peroxide, to form carbon-carbon links between elastomer molecular chains. The radiopaque elastomeric matrix may be used to create a flexible, lightweight, carbon-carbon linked, multilaminated protection material against ionizing radiation. The multilaminated protec tion material may include a mechanical reinforcement cloth layer to avoid material expansion or rupture; and additional external elastomeric layers for protection against aging, physical, biological and chemical hazards, as well as allowing mechanical memory of the material and easy cleaning, desinfection and sterilization. These layers are directly merged or incorporated into a single, fused sheet with the radiopaque elastomeric matrix, without the use of glues or adhesives, during a cure and pressure application wherein the elastomer molecules create reticulated carbon-carbon links between the internal and external elastomeric layers and through the pores of the reinforcement layer. The multilaminated material allows production of colored, flexible, lightweight, durable radiation protection articles for medical, dental, and industrial uses.

### FIELD OF THE INVENTION

The present invention relates to elastomeric substances mixed with a high proportion of high atomic number radiopaque substances, including lead oxide. The resultant radiopaque elastomeric matrix mixture is cured with non-sulfur reaction accelerators, including organic peroxides, to avoid the presence of sulfur and the formation of sulfur salts. The radiopaque elastomeric matrix may be used to create a flexible, lightweight, carbon-carbon linked, multilaminated protection material against ionizing radiation. The multilaminated protection material may include a mechanical reinforcement cloth layer and external elastomeric layers incorporated into a single, fused sheet with the radiopaque elastomeric matrix without the use of glues or adhesives. The incorporation is promoted through the cure and pressure application wherein the elastomer molecules create reticulated carbon-carbon links between the internal and external elastomeric layers and through the pores of the mechanical reinforcement layer.

### BACKGROUND OF THE INVENTION

Ionizing radiation, including x-radiation, is used to conduct many activities of the medical and dental sectors such as analysis of internal organ pathology; fracture study; treatment of tumors, cancers, bone diseases, and other ills. The tolerance of the human organism to this type of radiation is minimal, however, and propagation of x-ray waves involves inherent risks. Long or chronic exposure causes redness of the skin, blistering, ulceration, and in severe cases, may cause serious and/or cancerous lesions. Even diagnostic x-rays may increase the risk of developmental problems and cancer in those exposed.

Devices that aim to protect the areas of the body that are either highly exposed or that are particularly sensitive to ionizing radiation are well known in the art, and include protective clothing comprising a polymer matrix into which radiopaque substances have been incorporated. Typically, these radiopaque garments consist of a stiff material, such as rubber, impregnated by a heavy metal which is capable of blocking x-rays.

Lead is the most common shield against x-rays because of its high density, radiation wave stopping power, ease of installation, and low cost. Examples of lead impregnated radiopaque garments may be found in U.S. Pat. No. 3,052,799 to Holland; U.S. Pat. No. 3,185,751 to Sutton; U.S. Pat. No. 3,883,749 to Whittaker et al.; U.S. Pat. No. 3,045,121 to Leguillon; U.S. Pat. No. 3,569,713 to Via; and U.S. Pat. No. 5,038,047 to Still. The use of a mixture of lead and mercury has also been described, for example in GB 954593, for producing multilayer materials for protection against ionizing radiation.

However, while the lead-filled prior art garments provide a good measure of protection against the harmful effects of x-rays, these prior art garments are often heavy, stiff, expensive, bulky, and lacking in breathability. As such, these garments are often uncomfortable, cumbersome, and restrictive. Also, there are sterilization issues with these prior art garments because they are typically too bulky and expensive for a short lifetime and disposal after each use. To solve the problem related to cleaning, desinfection and sterilization, prior art has already shown the application of plastic external layers, usually made from PVC or high density polyethylene. However, the resulting product has increased weight and low flexibility, which severely reduces the comfort to the user of the protection article.

Moreover, the use of sulfur during the vulcanization process in the manufacturing of prior art lead-filled articles provokes a reaction between residual sulfur and the lead particles, generating lead sulfide salts. The use of lead-based particles and sulfur is known for especially accelerating the degradation phenomena in prior art mixtures formulated from natural latex, and therefore considerably reduces the usage time of the finished products of these mixtures. Lead sulfide salts induce faster chemical degradation of the polymeric material, which is visually identifiable due to the characteristic dark color related to the formation of lead sulfide. This aspect severely reduces the lifespan and resistance of the elastomeric material because this salt promotes undesired oxidation, which damages the rubber matrix. Thus, at a relatively high lead content, a natural latex mixture deteriorates too quickly and becomes unusable for manufacturing radio-attenuating gloves according to a dipping-type preparation process as disclosed in GB 954593.

Another problem related to the prior art manufacture of radioprotective elastomeric sheets is the “crumbling” problem: the susceptability to deformation, thinning and rupturing in the sheets that is due to the presence of the radiopaque substance, and that is promoted by the force of gravity. Thus, in the prior art, the higher the proportion of heavy metals incorporated into the elastomeric mixture, the more brittle the resulting material, and thus the greater the “crumbling” problem. To solve this issue, prior art has already shown that reinforcement layers made from resistant natural or synthetic fibers can be incorporated into the sheet. But, in some articles, this is done through the simple superposition of cloth layers, usually made from nylon, which are not directly attached to the protection layer with the radiopaque substance, and therefore cannot prevent the expansion and rupture of the internal protective layer. These external layers are also inadequate for cleaning, desinfection and sterilization procedures which are common in hospitals or dental offices due to their porous nature. Other articles shown in prior art solve the mechanical problem of the crumbling radiation protection layer through the use of a glue or adhesive substance to adhere the reinforcement layer to the protective layer. But the use of glue results in costs increase, weight increase, possible imperfections in the adherence of the layers, and reduction of the flexibility of the multilayer material as well.

Furthermore, lead is a toxic substance which must be handled very carefully, cannot be carelessly disposed of, and its use more generally poses an environmental problem requiring specific devices for disposal of the waste from the manufacturing process and also for the finished products. Lead interferes with a variety of body processes and is toxic to many organs and tissues including the heart, bones, intestines, kidneys, and reproductive and nervous systems. Symptoms of increased levels of lead in the body include abdominal pain, confusion, headache, anemia, irritability, and in severe cases seizures, coma, and death. Routes of exposure to lead include contaminated air, water, soil, food, and consumer products. Occupational exposure is a common cause of lead poisoning in adults.

Consequently, in view of lead's high density and toxicity, there has been movement away from its use in radioprotection in favor of more lightweight and less toxic metals. In one preferred embodiment in U.S. Pat. No. 6,828,578 to DeMeo et al., for example, a cloth surgical mask liner or an entire surgical mask may be impregnated with a relatively lightweight radiopaque material, such as barium, to impart radiopaque qualities. DeMeo et al. disclose that while these radiopaque materials may not be “lightweight” in absolute terms, they are certainly “lightweight” in relation to the heavyweight radiopaque lead compounds which are used in the prior art; thus, barium sulfate was stated to be the preferred radiopaque compound for that invention because, as compared with lead, it is lighter in weight, inexpensive, promotes breathability and has fewer known health hazards.

However, because the atomic number of barium (56) is much lower than that of lead (82), and the density of barium sulfate (4.50 g/cm³) is much lower than that of lead oxide (9.53 g/cm³), in order to have the same radiation protection levels, approximately three times more barium compounds than lead must be used. The thickness of an elastomeric material comprising a barium compound would therefore need to be much greater than the thickness of a lead-based material to achieve the same desired protection levels, and this would also result in higher weights, lower flexibilities, and crumbling problems associated with difficulties in incorporating such high amounts of radiopaque compounds into an elastomeric matrix as compared to lead oxide, for example. Consequently, a radiopaque garment comprising the “lightweight” barium compounds would be “heavyweight”, stiffer, more crumble-prone, and more expensive.

Therefore there remains a need for flexible, lightweight, relatively inexpensive elastomeric materials comprising a high proportion of radiopaque substances, including lead, that do not display the crumbling, toxicity, or chemical degradation problems of the prior art.

### SUMMARY OF THE INVENTION

To solve the problems described above, the present invention is based upon the incorporation of a high proportion of lead oxide, or other high atomic number radiopaque substances, into an elastomeric matrix mixture. The elastomeric matrix, highly loaded with heavy metals, may be used to produce multilayer radiation protection materials suitable in a wide area of applications, particularly where flexibility of the protection material may be desired, including as x-ray protective garments for hospitals and dental offices.

In the present invention, the peeling problem in a multilayer material related to low mechanical resistance to layer separation was solved through an innovative cure and pressure process. Without the use of glues and adhesives, an internal radiopaque elastomeric protection layer(s) is directly merged or fused with reinforcement cloth layer(s) and external pure elastomeric layers through the application of pressure during a concomitant process of continuous vulcanization. The multilaminated material of the present invention therefore displays higher resistance and integrity due to the absence of an adhesive material between layers, and also due to the higher resistance and integrity of the elastomer layers cured with a non-sulfur reaction accelerator such as an organic peroxide.

Vulcanization of the radiopaque elastomeric matrix and the material mixture, through the use of organic peroxides and other similarly suitable non-sulfur reaction accelerators, is based upon the formation of carbon-carbon links between elastomer molecular chains. The absence of sulfur in the production process, which has oxidative properties on elastomeric substances such as rubbers, results in a flexible, lightweight, carbon-carbon linked, radiopaque material with high durability. Further, the material will also display higher resistance to aging and to darkening characteristic of leakage of lead sulfide salts that are formed between sulfur and lead oxide during a sulfur-based vulcanization process.

Specific embodiments of the present invention are disclosed herein. However, it is to be understood that the disclosed embodiments are merely illustrative of the invention that may be embodied in various forms.

In one embodiment, a flexible, lightweight elastomeric matrix includes a high proportion of at least one high atomic number radiopaque substance or mixtures thereof.

In one embodiment, a flexible, lightweight, sulfur-free elastomeric matrix includes a high proportion of at least one high atomic number radiopaque substance or mixtures thereof.

In one embodiment, a flexible, lightweight, reticulated carbon-carbon linked elastomeric matrix includes a high proportion of at least one high atomic number radiopaque substance or mixtures thereof.

In one embodiment, a process for manufacturing a flexible, lightweight elastomeric matrix includes the steps of: selecting at least one elastomeric substance from the group consisting of natural or synthetic rubbers or mixtures thereof; selecting at least one high atomic number radiopaque substance or mixtures thereof; mixing the radiopaque substance in a high proportion to the elastomeric substance to form a mixture; and curing the mixture in the absence of sulfur.

In one embodiment, a process for manufacturing a flexible, lightweight, reticulated carbon-carbon linked elastomeric matrix includes the steps of: selecting at least one elastomeric substance from the group consisting of natural or synthetic rubbers or mixtures thereof; selecting at least one high atomic number radiopaque substance or mixtures thereof; mixing the radiopaque substance in a high proportion to the elastomeric substance to form a mixture; and curing the mixture with at least one vulcanization agent selected from the group consisting of organic peroxides or mixtures thereof.

In one embodiment, a flexible, multilaminated, elastomeric material includes at least three layers, wherein at least one layer is a lightweight elastomeric matrix comprising a high proportion of at least one high atomic number radiopaque substance or mixtures thereof.

In one embodiment, a flexible, multilaminated, adhesive-free elastomeric material includes at least three layers, wherein at least one layer is a lightweight elastomeric matrix comprising a high proportion of at least one high atomic number radiopaque substance or mixtures thereof.

In one embodiment, a flexible, multilaminated, reticulated carbon-carbon linked elastomeric material includes at least three layers, wherein at least one layer is a lightweight elastomeric matrix comprising a high proportion of at least one high atomic number radiopaque substance or mixtures thereof.

In one embodiment, a process for manufacturing a flexible, multilaminated, radiopaque elastomeric material includes the steps of: selecting at least one lightweight elastomeric matrix including a high proportion of at least one high atomic number radiopaque substance or mixtures thereof; selecting at least one porous, intermediate matrix; selecting at least one flexible, external matrix; and concomitantly compressing together and curing the matrices in the absence of sulfur.

In one embodiment, a process for manufacturing a flexible, multilaminated, carbon-carbon linked, radiopaque elastomeric material includes the steps of: selecting at least one lightweight elastomeric matrix including a high proportion of at least one high atomic number radiopaque substance or mixtures thereof; selecting at least one porous, intermediate matrix; selecting at least one flexible, external matrix; and concomitantly compressing together and curing the matrices with at least one vulcanization agent selected from the group consisting of organic peroxides or mixtures thereof.

### BRIEF DESCRIPTION OF THE DRAWINGS

FIG. 1 illustrates one embodiment of a flexible, multilaminated, carbon-carbon linked, radiopaque elastomeric material.

FIG. 2 illustrates organic peroxide mediated carbon-carbon reticulation.

FIG. 3 illustrates one embodiment of a porous, intermediate matrix through which carbon-carbon crosslinking between elastomeric layers of a multilaminated material may occur.

FIG. 4 illustrates one embodiment of a production method of a flexible, multilaminated, carbon-carbon linked, radiopaque elastomeric material.

### DETAILED DESCRIPTION

The present invention is described in detail below in connection with some embodiments for purposes of illustration only. Modifications to particular embodiments within the spirit and scope of the present invention, as set forth in the appended claims, will be readily apparent to those of ordinary skill in the art.

The present invention allows the use of its concepts with a wide variation of radiopaque substances and mixtures thereof, a wide variation of natural and synthetic elastomers and thermoplastics and mixtures thereof, and a wide variation of organic peroxides and non-sulfur reaction accelerators and mixtures thereof. There may also be variations in the specifications of the resulting products and in the methods for their industrial production.

As used herein, “elastomer” or “elastomeric substance” refers to any elastic polymer suitable for use in the production of a flexible layer or material.

As used herein, “radiopaque substance” refers to any substance or material that substantially prevents the penetration and passage of radiation.

As used herein, “organic peroxide” refers to any organic compound containing the bivalent R₁—O—O—R₂ structure that may promote reticulated carbon-carbon links.

As used herein, “thermoplastic” refers to any non-crosslinked polymer suitable for use in the production of a flexible layer or material.

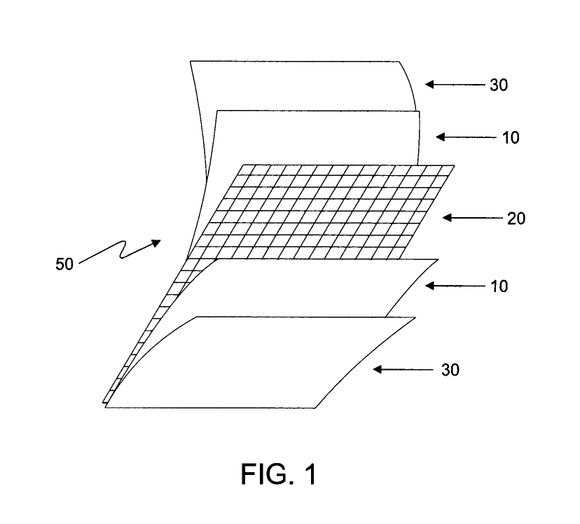

Referring particularly to the drawings, which show some embodiments of the present invention, there is illustrated in FIG. 1 a flexible, multilaminated, carbon-carbon linked, radiopaque elastomeric material 50 including: flexible external matrices/layers 30, radiopaque elastomeric matrices/layers 10, and a porous intermediate matrix/layer 20.

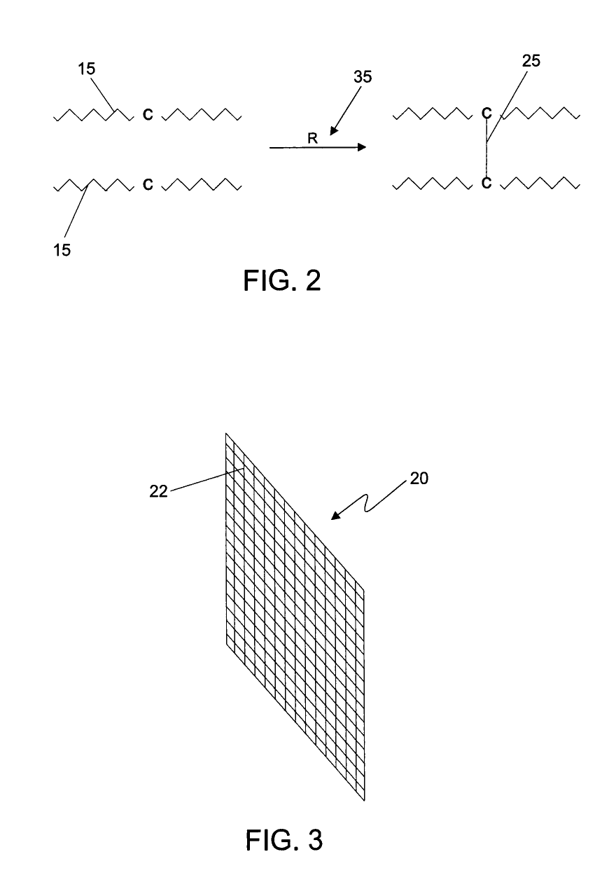

FIG. 2 illustrates an organic peroxide 35 mediated reticulation between elastomer molecular chains 15 forming carbon-carbon links 25. The organic peroxide 35 mediated cure chemically fuses together all the matrices/layers 10, 20, 30 of radiopaque multilaminated material 50.

Referring to FIG. 3, the pores 22 of a porous, intermediate matrix/layer 20 provide flexibility to the radiopaque multilaminated material 50, and also provide openings through which carbon-carbon links 25 between matrices/layers 10, 20, 30 of the radiopaque multilaminated material 50 may occur.

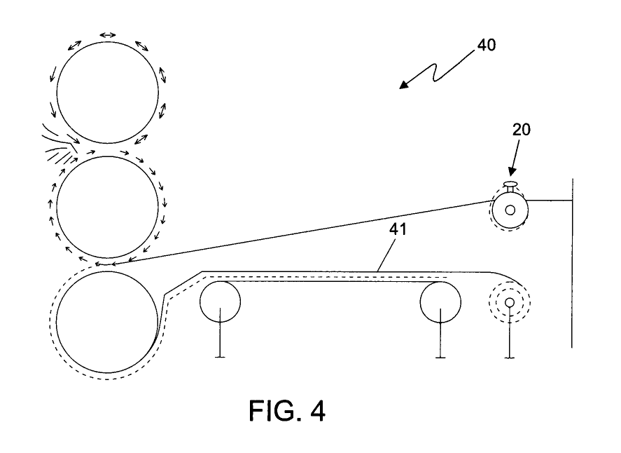

FIG. 4 illustrates one embodiment of a production method 40 of a radiopaque multilaminated material 50, and generally includes an industrial calendering system 41 for lamination and incorporation of a porous intermediate matrix 20 to a radiopaque elastomeric matrix 10 and an external matrix 30. Radiopaque substances and elastomers are homgenyzed into a banbury (closed mixer) and then accelerated to cure without the use of sulfur in a cyclinder (open mixer) through the use of an organic peroxide.

Radiopaque Elastomeric Matrix

The present invention is based upon the incorporation of a high proportion of high atomic number radiopaque substances, into a flexible, lightweight elastomeric matrix. The radiopaque elastomeric matrix 10 is cured with an organic peroxide 35 or other similarly suitable non-sulfur reaction accelerator. Thus, vulcanization of the matrix is based upon the formation of carbon-carbon links 25 between elastomer molecular chains 15, and the absence of sulfur in the curing process yields a flexible, lightweight, carbon-carbon linked, radiopaque elastomeric matrix 10 with high durability.

In one embodiment, a flexible, lightweight elastomeric matrix 10 includes a high proportion of at least one high atomic number radiopaque substance or mixtures thereof. In one embodiment, the elastomeric matrix 10 includes at least 70% by weight of a radiopaque substance or mixtures thereof. In one embodiment, the elastomeric matrix 10 includes at least 80% by weight of a radiopaque substance or mixtures thereof. In one embodiment, the elastomeric matrix 10 includes at least 85% by weight of a radiopaque substance or mixtures thereof.

In one embodiment, the radiopaque substance is an element with an atomic number equal to or greater than atomic number 40. In one embodiment, the radiopaque substance is bismuth, tungsten, barium, lead, iodine, tin, or mixtures thereof. In one embodiment, the radiopaque substance is a metal particle, a metal oxide, a metal salt, or a mixture thereof. In one embodiment, the radiopaque substance is a lead oxide powder.

In one embodiment, the elastomeric matrix 10 includes about 30% or less by weight of at least one elastomeric substance. In one embodiment, at least one elastomeric substance is a natural or synthetic rubber or a mixture thereof. In one embodiment, an elastomeric substance is natural rubber polyisoprene (NR), polybutadiene (BR), polyisoprene, polychloroprene, polyurethane, polymers or copolymers of acrylic (ACM), silicon synthetic rubbers, styrene rubber butadiene (SBR) copolymers, isobutylene-isoprene including butyl rubber, nitrile butadiene rubber (NBR), hydrogenated nitrile butadiene rubber (HNBR), styrene ethylene butylene styrene (SEBS), ethylene propylene diene terpolymer (EPDM), ethylene propylene copolymers (EPM), halogenated isobutene isoprene rubber (CIIR), epichlorohydrin (ECO), ethylene propylene rubber (EPR), acrylonitrile butadiene styrene (ABS), ethylene vinyl acetate (EVA), saturated ethylene vinyl acetate (EVM), polyethylene (PE), styrene butadiene styrene (SBS), styrene isoprene styrene (SIS), polyolefin elastomer (POE), polychloroprene (CR), thermoplastic elastomer (TPE), chlorinated polyethylene (CM), polychlorotrifluoroethylene (CFM), chlorosulfonated polyethylene (CSM), fluorosilicone rubber (FVMQ), methyl vinyl silicone rubber (MVQ), phenyl vinyl methyl silicone rubber (PVMQ), silicone rubber (VMO), pheynyl methyl silicone rubber (PVMO), phenyl silicone rubber (PMO), fluorocarbon elastomer (FKM), or a mixture thereof.

In one embodiment, the elastomeric matrix 10 includes a mixture of natural rubber and polybutadiene. In one embodiment, the mixture is about 20% to about 70% by weight of natural rubber, and about 20% to about 70% by weight of polybutadiene. In one embodiment, the mixture is about 50% by weight of natural rubber, and about 50% by weight of polybutadiene.

In one embodiment, the elastomeric matrix 10 is vulcanized in the absence of sulfur. In one embodiment, the matrix 10 is a flexible, lightweight, sulfur-free elastomeric matrix including a high proportion of at least one high atomic number radiopaque substance or mixtures thereof. In one embodiment, the sulfur-free elastomeric matrix 10 is vulcanized through the use of at least one organic peroxide 35 or a mixture thereof. In one embodiment, the organic peroxide 35 is dicumyl peroxide; BIS-(t-butylperoxy isopropyl)-benzene; 2,5-dimethyl-2,5-di-(t-butylperoxy)-hexane; 1,1-BIS-(t-butylperoxy)-3,3,5-trimethylcyclohexane; diacyl peroxide; BIS-(t-butyl peroxide); 2,5-BIS-(t-butylperoxy)-2,5-dimethylhexane; butyl-4,4-BIS-(t-butylperoxy)-valerate; dibenzoyl peroxide; BIS-(2,4-dichlorobenzoil)-peroxide; or a mixture thereof. In one embodiment, the one organic peroxide is 1,1-BIS-(t-butylperoxy)-3,3,5-trimethylcyclohexane.

In one embodiment, the elastomeric matrix 10 includes about 0.1% to about 10% by weight of at least one organic peroxide 35 or a mixture thereof. In one embodiment, the organic peroxide 35 promotes reticulated carbon-carbon links 25 between elastomer molecular chains 15 of the elastomeric matrix 10.

In one embodiment, the elastomeric matrix 10 is a flexible, lightweight, reticulated carbon-carbon linked elastomeric matrix including a high proportion of at least one high atomic number radiopaque substance or a mixture thereof. In one embodiment, the carbon-carbon linked matrix 10 is vulcanized in the absence of sulfur. In one embodiment, the carbon-carbon linked matrix 10 is vulcanized through the use of at least one organic peroxide 35 or a mixture thereof. In one embodiment, the organic peroxide 35 is dicumyl peroxide; BIS-(t-butylperoxy isopropyl)-benzene; 2,5-dimethyl-2,5-di-(t-butylperoxy)-hexane; 1,1-BIS-(t-butylperoxy)-3,3,5-trimethylcyclohexane; diacyl peroxide; BIS-(t-butyl peroxide); 2,5-BIS-(t-butylperoxy)-2,5-dimethylhexane; butyl-4,4-BIS-(t-butylperoxy)-valerate; dibenzoyl peroxide; BIS-(2,4-dichlorobenzoil)-peroxide; or a mixture thereof. In one embodiment, the organic peroxide 35 is 1,1-BIS-(t-butylperoxy)-3,3,5-trimethylcyclohexane. In one embodiment, the carbon-carbon linked matrix 10 includes about 0.1% to about 10% by weight of an organic peroxide 35 or a mixture thereof.

In one embodiment, the radiopaque elastomeric matrix 10 may be used as a barrier or protection against radiation. In one embodiment, the matrix 10 may be used as a barrier or protection against ionizing radiation. In one embodiment, the matrix 10 may be used as a barrier or protection against x-ray radiation. In one embodiment, the matrix 10 may be used to produce shields, barriers, containers, walls, bricks, sheets, curtains, screens, pieces of clothing, or any other artifacts with radiation protection or radiation barrier properties. In one embodiment, the matrix 10 may be used to produce a radiation protection or radiation barrier elastomeric material. In one embodiment, the matrix 10 may be used to produce a radiation protection or radiation barrier multilaminated elastomeric material 50.

In one embodiment, a process for manufacturing a flexible, lightweight elastomeric matrix 10 includes: selecting at least one elastomeric substance or a mixture thereof; selecting at least one high atomic number radiopaque substance or a mixture thereof mixing the radiopaque substance in a high proportion to the elastomeric substance to form a mixture; and curing the mixture in the absence of sulfur.

In one embodiment, a process for manufacturing a flexible, lightweight, reticulated carbon-carbon linked elastomeric matrix 10 includes: selecting at least one elastomeric substance or a mixture thereof selecting at least one high atomic number radiopaque substance or a mixture thereof; mixing the radiopaque substance in a high proportion to the elastomeric substance to form a mixture; and curing the mixture with at least one vulcanization agent including organic peroxides 35 or a mixture thereof, that promotes reticulated carbon-carbon links 25 between elastomer molecular chains 15 of the elastomeric matrix 10.

Multilaminated Radiopaque Materials

In order to increase mechanical memory and resistance, and to protect the elastomeric matrix 10 of the present invention from aging, and to allow cleaning and sterilization, the elastomeric matrix 10 may combined with other matrices/layers, and may be used to produce a multilaminated radiopaque material 50. The elastomeric matrix 10 may be fused with one or more reinforcement layers, and external pure elastomeric layers into a single sheet. The reinforcement layer made from ultraresistant polyesther fibers or cloth, or any other high tenacity fibers and cloths. Referring to FIG. 1, a multilaminated radiopaque material 50 may include, in one embodiment, the central reinforcement layer 20, the radiation protection layers 10 on either side, and the external elastomeric layers 30.

The multilaminated radiopaque material 50 may include an elastomeric matrix 10 impregnated with a high proportion of high atomic weight substances, a porous intermediate matrix 20, and a flexible external layer 30, fused to each other through the application of pressure during a concomitant process of continuous vulcanization promoted by an organic peroxide 35 reaction of the elastomeric layers 10, 30 during manufacture. Vulcanization of all material 50 matrices/layers with pressure creates carbon-carbon links 25 between the elastomeric molecular chains 15 of the different layers (external and internal) 10, 30. Without the use of adhesives or glues, these interlayer carbon-carbon links provoke a molecular adherence and incorporation of the different layers 10, 30.

The porous nature of the intermediate matrix 20, i.e., the “reinforcement layer”, allows elastomeric carbon-carbon crosslinking 25 through the pores 22 between the layers 10, 30 on opposite sides, and the reinforcement layer 20 is also deeply incorporated through the contact between the elastomers of the external and internal layers through the pores 22. The carbon-carbon links 25 promoted by an organic peroxide 35 reaction thus promotes the fusion of the material 50 layers 10, 30 through the reinforcement grid layer 20. This results in a perfect incorporation of the reinforcement layer 20 and the flexible external layers 30 with the elastomer molecules 15 of the radiation protection layers 10 during vulcanization through reticulated carbon-carbon links 35 between all layers 10, 20, 30 of a flexible multilaminated material 50.

The flexible external layers 30 are designed to protect the radiopaque elastomer layer 10 from chemical and physical degradation; to prevent any contamination of the user or leakage of the radiopaque substance to the environment; to promote higher mechanical memory of the protection material 50; to protect the radiopaque material from light, infrared radiation or oxygen chemical attack; and to allow cleaning and sterilization of the protection articles with alcohol, peracetic acid, detergents or other compatible chemicals, which is very important especially for medical and dental applications. The external layers 30 may also be specifically designed to isolate the radiopaque compound, preventing contamination of the user or contamination of the environment.

In one embodiment, a flexible, multilaminated elastomeric material 50 includes at least three layers, wherein at least one layer is a lightweight elastomeric matrix 10 including a high proportion of at least one high atomic number radiopaque substance or a mixture thereof.

In one embodiment, at least one layer is a porous, intermediate matrix 20. In one embodiment, the porous, intermediate matrix 20 is a reinforcing grid of fibrous material to increase mechanical resistance of the material to deformation or ruptures. In one embodiment, the reinforcing grid 20 is formed from a synthetic or natural fiber or mixtures thereof. In one embodiment, a reinforcing grid 20 is formed from a high tenacity polyester or mixtures thereof. In one embodiment, the reinforcing grid 20 may have pores 22 from about 0.01 mm to about 10 mm in diameter. In one embodiment, the pores 22 are about 0.1 mm to about 2 mm in diameter. In one embodiment, the reinforcing grid 20 may have fiber lines from about 0.1 mm to about 2 mm in thickness. In one embodiment, the porous, intermediate matrix 20 is compacted or merged to the radiopaque elastomeric matrix 10 without the use of adhesive substances or glues. In one embodiment, the porous, intermediate matrix 20 is compacted or merged to the radiopaque elastomeric matrix 10 through pressure during a vulcanization process.

In one embodiment, at least one layer is an external elastomeric layer 30 that may be applied to external sides of a multilaminated radiopaque material 50. In one embodiment, the external elastomeric layer 30 is a natural or synthetic rubber, a flexible thermoplastic, or a mixture thereof. In one embodiment, the external elastomeric layer 30 is natural rubber polyisoprene (NR), polybutadiene (BR), polyisoprene, polychloroprene, polyurethane, polymers or copolymers of acrylic (ACM), silicon synthetic rubbers, styrene rubber butadiene (SBR) copolymers, isobutylene-isoprene including butyl rubber, nitrile butadiene rubber (NBR), hydrogenated nitrile butadiene rubber (HNBR), styrene ethylene butylene styrene (SEBS), ethylene propylene diene terpolymer (EPDM), ethylene propylene copolymers (EPM), halogenated isobutene isoprene rubber (CIIR), epichlorohydrin (ECO), ethylene propylene rubber (EPR), acrylonitrile butadiene styrene (ABS), ethylene vinyl acetate (EVA), saturated ethylene vinyl acetate (EVM), polyethylene (PE), styrene butadiene styrene (SBS), styrene isoprene styrene (SIS), polyolefin elastomer (POE), polychloroprene (CR), thermoplastic elastomer (TPE), chlorinated polyethylene (CM), polychlorotrifluoroethylene (CFM), chlorosulfonated polyethylene (CSM), fluorosilicone rubber (FVMQ), methyl vinyl silicone rubber (MVQ), phenyl vinyl methyl silicone rubber (PVMQ), silicone rubber (VMO), pheynyl methyl silicone rubber (PVMO), phenyl silicone rubber (PMO), fluorocarbon elastomer (FKM), polyvinyl chloride (PVC), polypropylene (PP), olefin sulfonate (OS), polyethylene (PE), polyester urethane (AU), polyether urethane (EU), or a mixture thereof. In one embodiment, the external elastomeric layer 30 is a mixture of about 10% to about 50% by weight of nitrile butadiene rubber (NBR), and of about 50% to about 90% by weight of polychloroprene (CR). In one embodiment, the external elastomeric layer 30 may incorporate multiple colorants to produce materials and articles with a wide range of colors.

In one embodiment, the external elastomeric layer 30, the porous intermediate matrix 20, and the radiopaque elastomeric matrix 10, is compacted or merged to each other through pressure during a vulcanization process. In one embodiment, the external elastomeric layer 30, the porous intermediate matrix 20, and the radiopaque elastomeric matrix 10, may be disposed in multiple distributions.

In one embodiment, the multilaminated radiopaque material 50 is a flexible, multilaminated, adhesive-free elastomeric material comprising at least three layers, wherein at least one layer is a radiopaque elastomeric matrix 10 including a high proportion of at least one high atomic number radiopaque substance or mixtures thereof. In one embodiment, the layers of the flexible, multilaminated, adhesive-free elastomeric material 50 are compacted or merged to each other through pressure during a vulcanization process. In one embodiment, the adhesive-free multilaminated material 50 includes at least two external elastomeric layers 30, wherein the external elastomeric layers 30 are compacted or merged to each other through pressure during a vulcanization process. In one embodiment, the vulcanization process occurs in the absence of sulfur.

In one embodiment, the vulcanization process of an adhesive-free multilaminated material 50 is promoted through the use of at least one organic peroxide 35 or mixtures thereof. In one embodiment, the organic peroxide 35 is dicumyl peroxide; BIS-(t-butylperoxy isopropyl)-benzene; 2,5-dimethyl-2,5-di-(t-butylperoxy)-hexane; 1,1-BIS-(t-butylperoxy)-3,3,5-trimethylcyclohexane; diacyl peroxide; BIS-(t-butyl peroxide); 2,5-BIS-(t-butylperoxy)-2,5-dimethylhexane; butyl-4,4-BIS-(t-butylperoxy)-valerate; dibenzoyl peroxide; BIS-(2,4-dichlorobenzoil)-peroxide; or a mixture thereof. In one embodiment, the organic peroxide 35 is 1,1-BIS-(t-butylperoxy)-3,3,5-trimethylcyclohexane. In one embodiment, the organic peroxide 35 is added in an amount of from about 0.1% to about 10% by weight to a mixture including an external elastomeric layer 30 substance. In one embodiment, the organic peroxide 35 promotes reticulated carbon-carbon links 25 between elastomer molecular chains 15 of external elastomeric layers 30.

In one embodiment, a multilaminated radiopaque material 50, is a flexible, multilaminated, reticulated carbon-carbon linked elastomeric material including at least three layers, wherein at least one layer is a radiopaque elastomeric matrix 10 comprising a high proportion of at least one high atomic number radiopaque substance or mixtures thereof. In one embodiment, the carbon-carbon linked material 50 is sulfur-free. In one embodiment, the carbon-carbon linked material 50 includes external elastomeric layers 30, wherein the external elastomeric layers 30 are resistant to stains and degradation promoted by the migration of sulfur salts. In one embodiment, the external elastomeric layers 30 are resistant to chemical, physical, and UV radiation damage.

In one embodiment, a process 40 for manufacturing a flexible, multilaminated, radiopaque elastomeric material 50 includes the steps of: selecting at least one radiopaque elastomeric matrix 10 including a high proportion of at least one high atomic number radiopaque substance or mixtures thereof; selecting at least one porous, intermediate matrix 20; selecting at least one flexible, external matrix 30; and concomitantly compressing together and curing said matrices 10, 20, 30 in the absence of sulfur. In one embodiment, the matrices 10, 20, 30 are compressed together into a multilaminated elastomeric material 50 without the use of adhesives or glues. In one embodiment, the matrices 10, 20, 30 and the multilaminated material 50 may be produced with variable thickness. In one embodiment, the radiopaque elastomeric matrix 10 may be from about 0.1 mm to about 100 mm in thickness. In one embodiment, the radiopaque elastomeric matrix 10 may be from about 0.3 mm to about 5 mm in thickness. In one embodiment, the radiopaque elastomeric matrix 10 may be from about 0.1 mm to about 100 mm in thickness. In one embodiment, the external elastomeric matrix 30 may be from about 0.1 mm to about 2 mm in thickness. In one embodiment, the multilaminated, radiopaque elastomeric material 50 is from about 0.3 mm to about 10 mm in thickeness. In one embodiment, the multilaminated, radiopaque elastomeric material 50 can be used to block x-rays from up to 150 Kv output during examinations or procedures which uses x-rays.

In one embodiment, the multilaminated radiopaque material 50 and protective items made therefrom may be cleaned and sterilized with disinfectants and chemicals sterilizers, including alcohol, peracetic acid, hydrogen peroxide and detergents. In one embodiment, the multilaminated radiopaque material 50 and protective items made therefrom retain high flexibility, low weight and improved comfort for a user. In one embodiment, the multilaminated radiopaque material 50 and protective items made therefrom include external elastomeric layers 30, wherein the external elastomeric layers 30 prevent any contact or contamination of a user with a radiopaque substance. In one embodiment, the external elastomeric layers 30 prevent any leakage of the radiopaque substance to the environment. In one embodiment, the external elastomeric layers 30 prevent oxygen, chemicals or UV radiation to reach and promote either degradation of the lightweight elastomeric matrix 10 or of the multilaminated material 50. In one embodiment, the multilaminated radiopaque material 50 and protective items made therefrom are resistant to aging through chemical, radiation or physical damage. In one embodiment, the multilaminated radiopaque material 50 and protective items made therefrom may be any piece of clothing or article used to cover the human body or its parts. In one embodiment, the multilaminated radiopaque material 50 and protective items made therefrom may be used for protection or barrier against x-rays, ionizing rays and radiations used in radiotherapy and diagnostic examinations.

In one embodiment, a process 40 for manufacturing a flexible, multilaminated, carbon-carbon linked, radiopaque elastomeric material 50 includes the steps of: selecting at least one lightweight elastomeric matrix 10 including a high proportion of at least one high atomic number radiopaque substance or a mixture thereof; selecting at least one porous, intermediate matrix 20; selecting at least one flexible, external matrix 30; and concomitantly compressing together and curing said matrices 10, 20, 30 with at least one vulcanization agent that is an organic peroxide 35 or a mixture thereof.

### EXAMPLES

### Example 1

### Radiopaque Elastomeric Matrix Formula

| Ingredient: | PHR % |
|---|---|
| Natural rubber | 50:00 |
| Polybutadiene | 50:00 |
| Lead Oxide | 700:00 |
| Organic Peroxide | 3:00 |
| TOTAL: | 803:00 |

### External Elastomeric Layer Formula

| Ingredient: | PHR % |
|---|---|
| Nitrilic rubber (NBR) | 70:00 |
| Neoprene | 30:00 |
| Magnesium oxide | 4:00 |
| Stearin | 0.5:00 |
| Calcium silicate | 30:00 |
| DOP | 5:00 |
| Organic Peroxide | 4:00 |
| Pigment | 1:50 |

### Production Method

Phase One:

In one embodiment, lead oxide is incorporated into a mixture of natural rubber and polybutadiene. The material mass, including the lead oxide and the elastomeric mixture, is sent to a calendering system including a banbury mixer and cylinder. The radiopaque substance and the elastomers are homgenyzed into a banbury (closed mixer) and then accelerated to cure without the use of sulfur in a cylinder (open mixer), where it obtains the shape of a material sheet with the desired thickness. The reinforcement layer of polyesther is directly inserted in the calendering system where it is incorporated into the radiopaque layer through continuous pressure. This method reduces costs and does not require the use of glue or adhesives.

Phase Two:

The radiopaque layer with the reinforcement cloth layer is again sent to the calendering system. The system produces the external elastomeric layers in the desired thickness and the system incorporates the external layers to the internal radiopaque layer and reinforcement layer through continuous pressure. The concomitant cure or vulcanization during this process forms a series of carbon-carbon links between the elastomer molecular chains of the different elastomeric layers (radiopaque and external layers) and through the reinforcement layer. The end product is a multilaminated radiopaque material sheet with a complete fusion of the layers without use of glue or adhesives. In one example, the multilaminated radiopaque material has a thickness varying from 0.3 mm to 10 mm which can be used to block x-rays from up to 150 Kv output during examinations or procedures which uses x-rays. The material can then be cut and arranged to create many types of protection articles.

The previous example is provided solely to enable a person skilled in the art to make or use the present invention. Various modifications to these embodiments will be readily apparent to those skilled in the art, and the generic principles defined herein can be applied to other embodiments without departing from the spirit or scope of the invention.

1. A flexible, lightweight elastomeric matrix comprising a high proportion of at least one high atomic number radiopaque substance or mixtures thereof.

2. The flexible, lightweight elastomeric matrix of claim 1, wherein said radiopaque substance or mixtures thereof comprises at least 70% by weight of said elastomeric matrix.

3. The flexible, lightweight elastomeric matrix of claim 1, wherein said radiopaque substance or mixtures thereof comprises at least 80% by weight of said elastomeric matrix.

4. The flexible, lightweight elastomeric matrix of claim 1, wherein said radiopaque substance or mixtures thereof comprises at least 85% by weight of said elastomeric matrix.

5. The flexible, lightweight elastomeric matrix of claim 1, wherein said radiopaque substance is selected from the group consisting of: elements with atomic numbers equal to or greater than atomic number 40.

6. The flexible, lightweight elastomeric matrix of claim 5, wherein said radiopaque substance is selected from the group consisting of: bismuth, tungsten, barium, lead, iodine, tin, and mixtures thereof.

7. The flexible, lightweight elastomeric matrix of claim 6, wherein said radiopaque substance is a metal particle, a metal oxide, a metal salt, or mixtures thereof.

8. The flexible, lightweight elastomeric matrix of claim 7, wherein said radiopaque substance is a lead oxide powder.

9. The flexible, lightweight elastomeric matrix of claim 1, wherein said elastomeric matrix comprises about 30% or less by weight of at least one elastomeric substance.

10. The flexible, lightweight elastomeric matrix of claim 1, wherein said elastomeric matrix comprises at least one elastomeric substance selected from the group consisting of: natural or synthetic rubbers or mixtures thereof.

11. The flexible, lightweight elastomeric matrix of claim 10, wherein said at least one elastomeric substance is selected from the group consisting of: natural rubber polyisoprene (NR), polybutadiene (BR), polyisoprene, polychloroprene, polyurethane, polymers or copolymers of acrylic (ACM), silicon synthetic rubbers, styrene rubber butadiene (SBR) copolymers, isobutylene-isoprene including butyl rubber, nitrile butadiene rubber (NBR), hydrogenated nitrile butadiene rubber (HNBR), styrene ethylene butylene styrene (SEBS), ethylene propylene diene terpolymer (EPDM), ethylene propylene copolymers (EPM), halogenated isobutene isoprene rubber (CIIR), epichlorohydrin (ECO), ethylene propylene rubber (EPR), acrylonitrile butadiene styrene (ABS), ethylene vinyl acetate (EVA), saturated ethylene vinyl acetate (EVM), polyethylene (PE), styrene butadiene styrene (SBS), styrene isoprene styrene (SIS), polyolefin elastomer (POE), polychloroprene (CR), thermoplastic elastomer (TPE), chlorinated polyethylene (CM), polychlorotrifluoroethylene (CFM), chlorosulfonated polyethylene (CSM), fluorosilicone rubber (FVMQ), methyl vinyl silicone rubber (MVQ), phenyl vinyl methyl silicone rubber (PVMQ), silicone rubber (VMO), pheynyl methyl silicone rubber (PVMO), phenyl silicone rubber (PMO), fluorocarbon elastomer (FKM), and mixtures thereof.

12. The flexible, lightweight elastomeric matrix of claim 11, wherein said elastomeric matrix comprises a mixture of natural rubber and polybutadiene.

13. The flexible, lightweight elastomeric matrix of claim 12, wherein said elastomeric matrix comprises a mixture of from about 20% to about 70% by weight to natural rubber, and from about 20% to about 70% by weight of polybutadiene.

14. The flexible, lightweight elastomeric matrix of claim 13, wherein said elastomeric matrix comprises a mixture of about 50% by weight of natural rubber to about 50% by weight of polybutadiene.

15. The flexible, lightweight elastomeric matrix of claim 1, wherein said elastomeric matrix is vulcanized in the absence of sulfur.

16. A flexible, lightweight, sulfur-free elastomeric matrix comprising a high proportion of at least one high atomic number radiopaque substance or mixtures thereof.

17. The flexible, lightweight, sulfur-free elastomeric matrix of claim 16, wherein said elastomeric matrix is vulcanized in the absence of sulfur.

18. The flexible, lightweight, sulfur-free elastomeric matrix of claim 16, wherein said elastomeric matrix is vulcanized through the use of at least one organic peroxide or mixtures thereof.

19. The flexible, lightweight, sulfur-free elastomeric matrix of claim 18, wherein said at least one organic peroxide is selected from the group consisting of: dicumyl peroxide; BIS-(t-butylperoxy isopropyl)-benzene; 2,5-dimethyl-2,5-di-(t-butylperoxy)-hexane; 1,1-BIS-(t-butylperoxy)-3,3,5-trimethylcyclohexane; diacyl peroxide; BIS-(t-butyl peroxide); 2,5-BIS-(t-butylperoxy)-2,5-dimethylhexane; butyl-4,4-BIS-(t-butylperoxy)-valerate; dibenzoyl peroxide; BIS-(2,4-dichlorobenzoil)-peroxide; or mixtures thereof.

20. The flexible, lightweight, sulfur-free elastomeric matrix of claim 19, wherein said at least one organic peroxide is 1,1-BIS-(t-butylperoxy)-3,3,5-trimethylcyclohexane.

21. The flexible, lightweight, sulfur-free elastomeric matrix of claim 18, wherein said elastomeric matrix comprises from about 0.1% to about 10% by weight of at least one organic peroxide or mixtures thereof.

22. The flexible, lightweight, sulfur-free elastomeric matrix of claim 18, wherein said at least one organic peroxide or mixtures thereof promotes reticulated carbon-carbon links between elastomer molecular chains of said elastomeric matrix.

23. A flexible, lightweight, reticulated carbon-carbon linked elastomeric matrix comprising a high proportion of at least one high atomic number radiopaque substance or mixtures thereof.

24. The flexible, lightweight, reticulated carbon-carbon linked elastomeric matrix of claim 23, wherein said elastomeric matrix is vulcanized in the absence of sulfur.

25. The flexible, lightweight, reticulated carbon-carbon linked elastomeric matrix of claim 23, wherein said elastomeric matrix is vulcanized through the use of at least one organic peroxide or mixtures thereof.

26. The flexible, lightweight, reticulated carbon-carbon linked elastomeric matrix of claim 25, wherein said at least one organic peroxide is selected from the group consisting of: dicumyl peroxide; BIS-(t-butylperoxy isopropyl)-benzene; 2,5-dimethyl-2,5-di-(t-butylperoxy)-hexane; 1,1-BIS-(t-butylperoxy)-3,3,5-trimethylcyclohexane; diacyl peroxide; BIS-(t-butyl peroxide); 2,5-BIS-(t-butylperoxy)-2,5-dimethylhexane; butyl-4,4-BIS-(t-butylperoxy)-valerate; dibenzoyl peroxide; BIS-(2,4-dichlorobenzoil)-peroxide; or mixtures thereof.

27. The flexible, lightweight, reticulated carbon-carbon linked elastomeric matrix of claim 26, wherein said at least one organic peroxide is 1,1-BIS-(t-butylperoxy)-3,3,5-trimethylcyclohexane.

28. The flexible, lightweight, sulfur-free elastomeric matrix of claim 25, wherein said elastomeric matrix comprises from about 0.1% to about 10% by weight of at least one organic peroxide or mixtures thereof.

29. The flexible, lightweight elastomeric matrix of claim 1, 16, or 23, wherein said elastomeric matrix may be used as a barrier or protection against radiation.

30. The flexible, lightweight elastomeric matrix of claim 1, 16, or 23, wherein said elastomeric matrix may be used as a barrier or protection against ionizing radiation.

31. The flexible, lightweight elastomeric matrix of claim 1, 16, or 23, wherein said elastomeric matrix may be used as a barrier or protection against x-ray radiation.

32. The flexible, lightweight elastomeric matrix of claim 1, 16, or 23, wherein said elastomeric matrix may be used to produce shields, barriers, containers, walls, bricks, sheets, curtains, screens, pieces of clothing, or any other artifacts with radiation protection or radiation barrier properties.

33. The flexible, lightweight elastomeric matrix of claim 1, 16, or 23, wherein said elastomeric matrix may be used to produce a radiation protection or radiation barrier elastomeric material.

34. The flexible, lightweight elastomeric matrix of claim 1, 16, or 23, wherein said elastomeric matrix may be used to produce a radiation protection or radiation barrier multilaminated elastomeric material.

35. A process for manufacturing a flexible, lightweight elastomeric matrix comprising the steps of:
a. selecting at least one elastomeric substance from the group consisting of natural or synthetic rubbers or mixtures thereof;
b. selecting at least one high atomic number radiopaque substance or mixtures thereof;
c. mixing said radiopaque substance in a high proportion to said elastomeric substance to form a mixture; and
d. curing said mixture in the absence of sulfur.

36. The process of claim 35, wherein said at least one elastomeric substance is selected from the group consisting of: natural rubber polyisoprene (NR), polybutadiene (BR), polyisoprene, polychloroprene, polyurethane, polymers or copolymers of acrylic (ACM), silicon synthetic rubbers, styrene rubber butadiene (SBR) copolymers, isobutylene-isoprene including butyl rubber, nitrile butadiene rubber (NBR), hydrogenated nitrile butadiene rubber (HNBR), styrene ethylene butylene styrene (SEBS), ethylene propylene diene terpolymer (EPDM), ethylene propylene copolymers (EPM), halogenated isobutene isoprene rubber (CIIR), epichlorohydrin (ECO), ethylene propylene rubber (EPR), acrylonitrile butadiene styrene (ABS), ethylene vinyl acetate (EVA), saturated ethylene vinyl acetate (EVM), polyethylene (PE), styrene butadiene styrene (SBS), styrene isoprene styrene (SIS), polyolefin elastomer (POE), polychloroprene (CR), thermoplastic elastomer (TPE), chlorinated polyethylene (CM), polychlorotrifluoroethylene (CFM), chlorosulfonated polyethylene (CSM), fluorosilicone rubber (FVMQ), methyl vinyl silicone rubber (MVQ), phenyl vinyl methyl silicone rubber (PVMQ), silicone rubber (VMO), pheynyl methyl silicone rubber (PVMO), phenyl silicone rubber (PMO), fluorocarbon elastomer (FKM), and mixtures thereof.

37. The process of claim 36, wherein said elastomeric matrix comprises a mixture of natural rubber and polybutadiene.

38. The process of claim 37, wherein said elastomeric matrix comprises a mixture of from about 20% to about 70% by weight of natural rubber, and from about 20% to about 70% by weight of polybutadiene.

39. The process of claim 38, wherein said elastomeric matrix comprises a mixture of about 50% by weight of natural rubber to about 50% by weight of polybutadiene.

40. The process of claim 35, wherein said radiopaque substance is selected from the group consisting of: elements with atomic numbers equal to or greater than atomic number 40.

41. The process of claim 40, wherein said radiopaque substance is selected from the group consisting of: bismuth, tungsten, barium, lead, iodine, tin, and mixtures thereof.

42. The process of claim 41, wherein said radiopaque substance is a metal particle, a metal oxide, a metal salt, or mixtures thereof.

43. The process of claim 42, wherein said radiopaque substance is a lead oxide powder.

44. The process of claim 35, wherein said elastomeric matrix comprises about 30% or less by weight of said at least one elastomeric substance.

45. The process of claim 35, wherein said elastomeric matrix comprises at least 70% by weight of said at least one radiopaque substance.

46. The process of claim 35, wherein said elastomeric matrix comprises at least 80% by weight of said at least one radiopaque substance.

47. The process of claim 35, wherein said elastomeric matrix comprises at least 85% by weight of said at least one radiopaque substance.

48. The process of claim 35, wherein said mixture is cured in the absence of sulfur.

49. The process of claim 35, wherein said mixture is sulfur-free.

50. A process for manufacturing a flexible, lightweight, reticulated carbon-carbon linked elastomeric matrix comprising the steps of:
a. selecting at least one elastomeric substance from the group consisting of natural or synthetic rubbers or mixtures thereof;
b. selecting at least one high atomic number radiopaque substance or mixtures thereof;
c. mixing said radiopaque substance in a high proportion to said elastomeric substance to form a mixture; and
d. curing said mixture with at least one vulcanization agent selected from the group consisting of organic peroxides or mixtures thereof.

51. The process of claim 50, wherein said elastomeric substance is selected from the group consisting of: natural rubber polyisoprene (NR), polybutadiene (BR), polyisoprene, polychloroprene, polyurethane, polymers or copolymers of acrylic (ACM), silicon synthetic rubbers, styrene rubber butadiene (SBR) copolymers, isobutylene-isoprene including butyl rubber, nitrile butadiene rubber (NBR), hydrogenated nitrile butadiene rubber (HNBR), styrene ethylene butylene styrene (SEBS), ethylene propylene diene terpolymer (EPDM), ethylene propylene copolymers (EPM), halogenated isobutene isoprene rubber (CIIR), epichlorohydrin (ECO), ethylene propylene rubber (EPR), acrylonitrile butadiene styrene (ABS), ethylene vinyl acetate (EVA), saturated ethylene vinyl acetate (EVM), polyethylene (PE), styrene butadiene styrene (SBS), styrene isoprene styrene (SIS), polyolefin elastomer (POE), polychloroprene (CR), thermoplastic elastomer (TPE), chlorinated polyethylene (CM), polychlorotrifluoroethylene (CFM), chlorosulfonated polyethylene (CSM), fluorosilicone rubber (FVMQ), methyl vinyl silicone rubber (MVQ), phenyl vinyl methyl silicone rubber (PVMQ), silicone rubber (VMO), pheynyl methyl silicone rubber (PVMO), phenyl silicone rubber (PMO), fluorocarbon elastomer (FKM), and mixtures thereof.

52. The process of claim 51, wherein said elastomeric matrix comprises a mixture of natural rubber and polybutadiene.

53. The process of claim 52, wherein said elastomeric matrix comprises a mixture of from about 20% to about 70% by weight of natural rubber, and from about 20% to about 70% by weight of polybutadiene.

54. The process of claim 53, wherein said elastomeric matrix comprises a mixture of about 50% by weight of natural rubber to about 50% by weight of polybutadiene.

55. The process of claim 50, wherein said radiopaque substance is selected from the group consisting of elements with atomic numbers equal to or greater than atomic number 40.

56. The process of claim 55, wherein said radiopaque substance is selected from the group consisting of: bismuth, tungsten, barium, lead, iodine, tin, and mixtures thereof.

57. The process of claim 56, wherein said radiopaque substance is a metal particle, a metal oxide, a metal salt, or mixtures thereof.

58. The process of claim 57, wherein said radiopaque substance is a lead oxide powder.

59. The process of claim 50, wherein said elastomeric matrix comprises about 30% or less of said at least one elastomeric substance by weight.

60. The process of claim 50, wherein said elastomeric matrix comprises at least 70% by weight of said at least one radiopaque substance.

61. The process of claim 50, wherein said elastomeric matrix comprises at least 80% by weight of said at least one radiopaque substance.

62. The process of claim 50, wherein said elastomeric matrix comprises at least 85% by weight of said at least one radiopaque substance.

63. The process of claim 50, wherein said at least one vulcanization agent is selected from the group consisting of: dicumyl peroxide; BIS-(t-butylperoxy isopropyl)-benzene; 2,5-dimethyl-2,5-di-(t-butylperoxy)-hexane; 1,1-BIS-(t-butylperoxy)-3,3,5-trimethylcyclohexane; diacyl peroxide; BIS-(t-butyl peroxide); 2,5-BIS-(t-butylperoxy)-2,5-dimethylhexane; butyl-4,4-BIS-(t-butylperoxy)-valerate; dibenzoyl peroxide; BIS-(2,4-dichlorobenzoil)-peroxide; or mixtures thereof.

64. The process of claim 63, wherein said at least one vulcanization agent is 1,1-BIS-(t-butylperoxy)-3,3,5-trimethylcyclohexane.

65. The process of claim 50, wherein said elastomeric matrix comprises from about 0.1% to about 10% by weight of at least one organic peroxide or mixtures thereof.

66. The process of claim 50, wherein said at least one vulcanization agent promotes reticulated carbon-carbon links between elastomer molecular chains of said elastomeric matrix.

67. A flexible, multilaminated elastomeric material comprising at least three layers, wherein at least one said layer is a lightweight elastomeric matrix comprising a high proportion of at least one high atomic number radiopaque substance or mixtures thereof.

68. The flexible, multilaminated elastomeric material of claim 67, wherein at least one said layer is a porous, intermediate matrix.

69. The flexible, multilaminated elastomeric material of claim 68, wherein said porous, intermediate matrix is a reinforcing grid of fibrous material to increase mechanical resistance of the material to deformation or ruptures.

70. The flexible, multilaminated elastomeric material of claim 69, wherein said reinforcing grid is formed from a synthetic or natural fiber or mixtures thereof.

71. The flexible, multilaminated elastomeric material of claim 70, wherein said reinforcing grid is formed from a high tenacity polyester or mixtures thereof.

72. The flexible, multilaminated elastomeric material of claim 69, wherein said reinforcing grid may have pores from about 0.01 mm to about 10 mm in diameter.

73. The flexible, multilaminated elastomeric material of claim 69, wherein said reinforcing grid may have pores from about 0.1 mm to about 2 mm in diameter.

74. The flexible, multilaminated elastomeric material of claim 69, wherein said reinforcing grid may have fiber lines from about 0.1 mm to about 2 mm in thickness.

75. The flexible, multilaminated elastomeric material of claim 68, wherein said at least one porous, intermediate matrix is compacted or merged to said at least one lightweight elastomeric matrix without the use of adhesive substances or glues.

76. The flexible, multilaminated elastomeric material of claim 68, wherein said at least one porous, intermediate matrix is compacted or merged to said at least one lightweight elastomeric matrix through pressure during a vulcanization process.

77. The flexible, multilaminated elastomeric material of claim 67, wherein at least one layer is an external elastomeric layer that may be applied to external sides of said multilaminated elastomeric material.

78. The flexible, multilaminated elastomeric material of claim 77, wherein said external elastomeric layer is selected from the group consisting of: natural or synthetic rubbers, or flexible thermoplastics, or mixtures thereof.

79. The flexible, multilaminated elastomeric material of claim 75, wherein said external elastomeric layer is selected from the group consisting of: natural rubber polyisoprene (NR), polybutadiene (BR), polyisoprene, polychloroprene, polyurethane, polymers or copolymers of acrylic (ACM), silicon synthetic rubbers, styrene rubber butadiene (SBR) copolymers, isobutylene-isoprene including butyl rubber, nitrile butadiene rubber (NBR), hydrogenated nitrile butadiene rubber (HNBR), styrene ethylene butylene styrene (SEBS), ethylene propylene diene terpolymer (EPDM), ethylene propylene copolymers (EPM), halogenated isobutene isoprene rubber (CIIR), epichlorohydrin (ECO), ethylene propylene rubber (EPR), acrylonitrile butadiene styrene (ABS), ethylene vinyl acetate (EVA), saturated ethylene vinyl acetate (EVM), polyethylene (PE), styrene butadiene styrene (SBS), styrene isoprene styrene (SIS), polyolefin elastomer (POE), polychloroprene (CR), thermoplastic elastomer (TPE), chlorinated polyethylene (CM), polychlorotrifluoroethylene (CFM), chlorosulfonated polyethylene (CSM), fluorosilicone rubber (FVMQ), methyl vinyl silicone rubber (MVQ), phenyl vinyl methyl silicone rubber (PVMQ), silicone rubber (VMO), pheynyl methyl silicone rubber (PVMO), phenyl silicone rubber (PMO), fluorocarbon elastomer (FKM), polyvinyl chloride (PVC), polypropylene (PP), olefin sulfonate (OS), polyethylene (PE), polyester urethane (AU), polyether urethane (EU), and mixtures thereof.

80. The flexible, multilaminated elastomeric material of claim 79, wherein said external elastomeric layer comprises a mixture of about 10% to about 50% by weight of nitrile butadiene rubber (NBR), and of about 50% to about 90% by weight of polychloroprene (CR).

81. The flexible, multilaminated elastomeric material of claim 77, wherein said external elastomeric layer, said at least one porous, intermediate matrix, and said at least one lightweight elastomeric matrix is compacted or merged to each other through pressure during a vulcanization process.

82. The flexible, multilaminated elastomeric material of claim 77, wherein said external elastomeric layer, said at least one porous, intermediate matrix, and said at least one lightweight elastomeric matrix may be disposed in multiple distributions.

83. The flexible, multilaminated elastomeric material of claim 77, wherein said external elastomeric layer may incorporate multiple colorants to produce materials and articles with a wide range of colors.

84. A flexible, multilaminated, adhesive-free elastomeric material comprising at least three layers, wherein at least one said layer is a lightweight elastomeric matrix comprising a high proportion of at least one high atomic number radiopaque substance or mixtures thereof.

85. The flexible, multilaminated, adhesive-free elastomeric material of claim 84, wherein said at least three layers are compacted or merged to each other through pressure during a vulcanization process.

86. The flexible, multilaminated, adhesive-free elastomeric material of claim 85, comprising at least two external elastomeric layers, wherein said external elastomeric layers are compacted or merged to each other through pressure during a vulcanization process.

87. The flexible, multilaminated, adhesive-free elastomeric material of claim 86, wherein said vulcanization process occurs in the absence of sulfur.

88. The flexible, multilaminated, adhesive-free elastomeric material of claim 87, wherein said vulcanization process is promoted through the use of at least one organic peroxide or mixtures thereof.

89. The flexible, multilaminated, adhesive-free elastomeric material of claim 88, wherein said at least one organic peroxide is selected from the group consisting of: dicumyl peroxide; BIS-(t-butylperoxy isopropyl)-benzene; 2,5-dimethyl-2,5-di-(t-butylperoxy)-hexane; 1,1-BIS-(t-butylperoxy)-3,3,5-trimethylcyclohexane; diacyl peroxide; BIS-(t-butyl peroxide); 2,5-BIS-(t-butylperoxy)-2,5-dimethylhexane; butyl-4,4-BIS-(t-butylperoxy)-valerate; dibenzoyl peroxide; BIS-(2,4-dichlorobenzoil)-peroxide; or mixtures thereof.

90. The flexible, multilaminated, adhesive-free elastomeric material of claim 89, wherein said at least one organic peroxide is 1,1-BIS-(t-butylperoxy)-3,3,5-trimethylcyclohexane.

91. The flexible, multilaminated, adhesive-free elastomeric material of claim 88, wherein said at least one organic peroxide is added in an amount of from about 0.1% to about 10% by weight to a mixture comprising said external elastomeric layer substance.

92. The flexible, multilaminated, adhesive-free elastomeric material of claim 88, wherein said at least one organic peroxide promotes reticulated carbon-carbon links between elastomer molecular chains of said external elastomeric layers.

93. A flexible, multilaminated, reticulated carbon-carbon linked elastomeric material comprising at least three layers, wherein at least one said layer is a lightweight elastomeric matrix comprising a high proportion of at least one high atomic number radiopaque substance or mixtures thereof.

94. The flexible, multilaminated, reticulated carbon-carbon linked elastomeric material of claim 93, wherein said elastomeric material is sulfur-free.

95. The flexible, multilaminated, reticulated carbon-carbon linked elastomeric material of claim 94, wherein said elastomeric material comprises external elastomeric layers, and wherein said external elastomeric layers are resistant to stains and degradation promoted by the migration of sulfur salts.

96. The flexible, multilaminated, reticulated carbon-carbon linked elastomeric material of claim 93, wherein said elastomeric material comprises external elastomeric layers, and wherein said external elastomeric layers are resistant to chemical, physical, and UV radiation damage.

97. A process for manufacturing a flexible, multilaminated, radiopaque elastomeric material comprising the steps of:
a. selecting at least one lightweight elastomeric matrix comprising a high proportion of at least one high atomic number radiopaque substance or mixtures thereof;
b. selecting at least one porous, intermediate matrix;
c. selecting at least one flexible, external matrix; and
d. concomitantly compressing together and curing said matrices in the absence of sulfur.

98. The process of claim 97, wherein said matrices are compressed together into a multilaminated elastomeric material without the use of adhesives or glues.

99. The process of claim 97, wherein said matrices and said multilaminated material may be produced with variable thickness.

100. The process of claim 99, wherein said at least one lightweight elastomeric matrix may be from about 0.1 mm to about 100 mm in thickness.

101. The process of claim 99, wherein said at least one lightweight elastomeric matrix may be from about 0.3 mm to about 5 mm in thickness.

102. The process of claim 99, wherein said external elastomeric matrix may be from about 0.1 mm to about 100 mm in thickness.

103. The process of claim 99, wherein said external elastomeric matrix may be from about 0.1 mm to about 2 mm in thickness.

104. The process of claim 97, wherein said multilaminated material and protective items made therefrom may be cleaned and sterilized through disinfectants and chemicals sterilizers, including alcohol, peracetic acid, hydrogen peroxide and detergents.

105. The process of claim 97, wherein said multilaminated material and protective items made therefrom retain high flexibility, low weight and improved comfort for a user.

106. The process of claim 97, wherein said multilaminated material and protective items made therefrom comprise external elastomeric layers, and wherein said external elastomeric layers prevent any contact or contamination of a user with a radiopaque substance.

107. The process of claim 97, wherein said multilaminated material and protective items made therefrom comprise external elastomeric layers, and wherein said external elastomeric layers prevent any leakage of the radiopaque substance to the environment.

108. The process of claim 97, wherein said multilaminated elastomeric material and protective items made therefrom comprise external elastomeric layers, and wherein said external elastomeric layers prevent oxygen, chemicals or UV radiation to reach and promote either degradation of said lightweight elastomeric matrix or of said multilaminated material.

109. The process of claim 97, wherein said multilaminated material and protective items made therefrom are resistant to aging through chemical, radiation or physical damage.

110. The process of claim 97, wherein said multilaminated material and protective items made therefrom may be any piece of clothing or article used to cover the human body or its parts.

111. The process of claim 97, wherein said multilaminated material and protective items made therefrom may be used for protection or barrier against x-rays, ionizing rays and radiations used in radiotherapy and diagnostic examinations.

112. A process for manufacturing a flexible, multilaminated, carbon-carbon linked, radiopaque elastomeric material comprising the steps of:
a. selecting at least one lightweight elastomeric matrix comprising a high proportion of at least one high atomic number radiopaque substance or mixtures thereof;
b. selecting at least one porous, intermediate matrix;
c. selecting at least one flexible, external matrix; and
d. concomitantly compressing together and curing said matrices with at least one vulcanization agent selected from the group consisting of organic peroxides or mixtures thereof.
